(19) United States
(12) Patent Application Publication
(10) Pub. No.: US 2006/0143001 A1
(43) Pub. Date: Jun. 29, 2006

(54) Method for the adaptation of comfort noise generation parameters

(75) Inventor: Nitin Arora, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Aktiengesellschaft

(21) Appl. No.: 11/321,482

(22) Filed: Dec. 29, 2005

(30) Foreign Application Priority Data
Dec. 29, 2004 (DE) 102004063290.1 DE

(51) Int. Cl. G10L 19/14

(52) U.S. Cl. 704/205

(57) ABSTRACT

In order to adapt comfort noise generation (CNG) parameters CNP, which are provided for generating a background noise signal in a telecommunications system 1 consisting of a packet-oriented telecommunications network 4 and at least a first and second communications device 2,3 connected thereto, firstly the CNG parameters CNP are generated in at least the first communications device 2 and transmitted, inserted in at least one silence insertion descriptor (SID) transmission frame SID via the packet-oriented telecommunications network 4 to the second communications device 3. The transmitted CNG parameters CNP are compared with a predetermined CNG parameter format CNPF and, if there is a deviation from the predetermined CNG parameter format CNPF, adapted to the predetermined CNG parameter format CNPF in that the individual CNG parameter CNP is removed and/or errored, absent or incompatible CNG parameters CNP are replaced by predetermined set CNG parameters SCNP.

### CROSS REFERENCE TO RELATED APPLICATIONS

This application claims priority to the German application No. 102004063290.1 DE filed Dec. 29, 2004, which is incorporated by reference herein in its entirety.

### FIELD OF INVENTION

The present invention relates to a method for the adaptation of comfort noise generation (CNG) parameters, which are provided for generating a background noise signal in a telecommunications system consisting of a packet-oriented telecommunications network and at least a first and second communications device connected thereto. The CNG parameters are generated in the first communications device and transmitted, inserted in at least one silence insertion descriptor (SID) transmission frame, via the packet-oriented telecommunications network to the second communications device.

### BACKGROUND OF INVENTION

Due to an increasing global orientation of companies, the use of telecommunications services for transmitting voice and data is constantly increasing. The consequence of this is that the costs which the telecommunications services give rise to are constantly increasing and becoming a substantial cost factor for companies which are looking for ways of reducing these costs. One way of being able to transmit data, especially voice data, cost-effectively and globally is provided by global and local computer networks, such as for example an intranet or the internet. Here, real-time-critical data, for example voice and video data, is also being transmitted increasingly via local and global packet-oriented telecommunications systems.

In telecommunications systems of this type, in particular systems implemented in accordance with Voice over Internet Protocol (IP) technology or Code Division Multiple Access (CDMA) technology, the pauses in talking or listening phases of an interlocutor occurring for example in an IP telephone call can advantageously be used to reduce the data volume to be transmitted within the telecommunications system. To this end, when, for example, pauses occur in the speech of an interlocutor, instead of a real background noise only several parameters describing the background noise are transmitted in a transmission frame provided for this purpose, from which a pleasant artificial background noise signal (“comfort noise signal”) is generated in the receiving station so that the impression is conveyed to the interlocutor currently speaking that the telecommunications connection is also continuing in the return direction.

These parameters consequently describe the strength of the noise signal and its spectral properties and are designated in the literature “silence insertion descriptor (SID) information” or “comfort noise generation (CNG) parameters”. In the receiving unit, the CNG parameters are used for generating a pleasant artificial background noise (“comfort noise generation”). In this context, a plurality of different methods for generating CNG parameters and the subsequent restoration of the background noise (“comfort noise generation”) are known which require both in the receiving unit and in the transmitting unit implemented and predefined and at least partially standardized protocols for the exchange of CNG parameters.

A non-binding definition of such CNG parameters with regard to the transmission frame to be used or the “comfort noise payload” transmitted in a data packet is made in standard G.711 appendix II of the ITU Telecommunication Standardization Section (ITU-T) which already stipulates that the “comfort noise payload” can comprise a parameter specifying the loudness level of the noise signal and multiple parameters specifying the spectral properties of the background noise in the form of filter coefficients. However, in the case of multiple different gateway computer systems, for example, no binding framework conditions with regard to the structure and use of the SID transmission frame are set by the ITU-T standard G.711 appendix II for “Interworking Scenarios”, so that different configurations of the SID transmission frame used and of the CNG parameters contained therein may exist within the different telecommunications systems.

Particularly in telecommunications systems operating in accordance with Voice-Over-IP or CDMA technology, in an SID transmission frame of this type, for example, either exclusively the loudness parameters (“quantized energy level”) or additionally the spectral parameters are transmitted in the form of filter coefficients (“quantized reflection coefficients”), it being possible for the number of filter coefficients here to vary significantly from application case to application case. This results in SID transmission frames of differing lengths between 1 byte and 15 bytes. Also, no explicit guidance is given by the ITU-T standard G.711 appendix II for determining the magnitude of the parameters, so that even the parameters contained in the SID transmission frames regarding the values assumed by them can spread to a broad extent. Such differently configured sets of CNG parameters result in a significant deterioration in the background noise generated, which in extreme cases, for example, can take on such a high loudness level that the actual voice signal is drowned out or at least interfered with.

### SUMMARY OF INVENTION

Anobject of the present invention is consequently to indicate a method for adapting CNG parameters transmitted in at least one SID transmission frame for generating a background noise signal in a packet-oriented telecommunications system, wherein CNG parameters of very varying configuration or methods for generating such sets of CNG parameters are supported and a background noise signal having approximately equally good signal properties in each case is generated.

The object is achieved by the independent claims.

The essential advantage of the inventive method is to be seen in the fact that the transmitted CNG parameters are compared with a predetermined CNG parameter format and, if there is a deviation from the predetermined CNG parameter format, adapted to match the predetermined CNG parameter format in that individual CNG parameters are removed and/or errored, missing or incompatible CNG parameters are replaced by predetermined set CNG parameters. Advantageously, high loudness levels of the background noise signal which drown out or interfere with the actual voice signal can be avoided by sifting out superfluous and/or replacing missing or errored CNG parameters with default parameters. The method is also suitable in particular for use within different gateway computer systems with different “interworking scenarios”.

Also advantageously, the number of transmitted CNG parameters is restricted by the predetermined CNG parameter format to a maximum of 11 parameters, comprising one QEL parameter and 10 QRC coefficients. The restriction of the number of parameters to a maximum of 11 parameters, of which 10 are configured as spectral parameters, enables the use of commercially available filter units and reduces the outlay both in terms of hardware implementation and in terms of computation within the telecommunications system.

Advantageous further developments of the invention are indicated in the dependent claims.

### BRIEF DESCRIPTION OF THE DRAWINGS

An exemplary embodiment of the invention is explained in detail below with reference to schematic block diagrams, in which:

FIG. 1 shows by way of example a telecommunications system, in particular for the transmission of voice-data signals;

FIG. 2 shows by way of example the first byte of an SID transmission frame specifying the loudness level;

FIG. 3 shows by way of example the comfort noise payload of an SID transmission frame and

FIG. 4 shows by way of example in a flow diagram the individual method steps for adapting the CNG parameters.

### DETAILED DESCRIPTION OF INVENTION

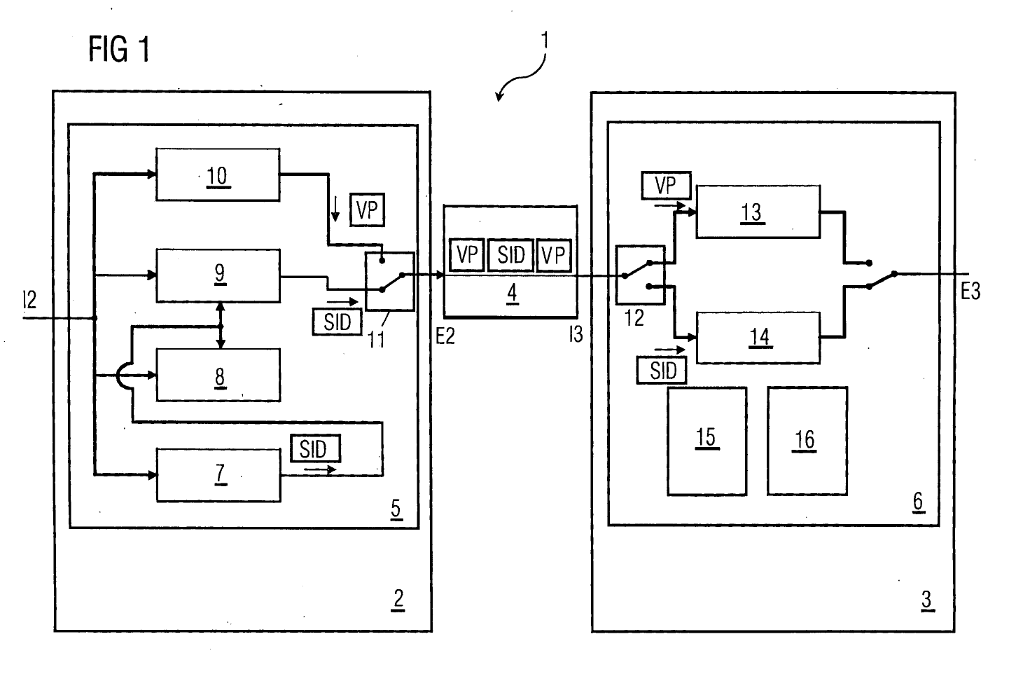

FIG. 1 shows by means of a schematic structural diagram an example of a telecommunications system 1, in particular a packet-oriented telecommunications system, that comprises a first communications device 2 and a second communications device 3 which are connected to one another for example via a packet-oriented or IP-oriented communications network 4. The transmission of data via the IP-oriented communications network 4 takes place in this case by means of data packets. For example, the first and second communications devices 2, 3 can be configured as gateway computer systems which have a differing technical structure and are connected in turn to the communications terminal equipment such as, for example, an IP telephone or client computer systems, etc. (not shown in the Figures). Furthermore, there are provided, for example, in the first communications device 2 a transmitter unit 5 and in the second communications device 3 a receiver unit 6 which are configured for the transmission of data packets via the IP-oriented communications network 4 in accordance, for example, with the transmission standard G.711 of the ITU. As an alternative, the transmission standard G.726 of the ITU can also be used.

In order to reduce the transmission rate within the IP-oriented communications network 4, the transmitter unit 5 has a “voice activity detection (VAD)” unit 7 which is connected via a connection line, for example, to an input I2 of the first communications device 2 and which supports “voice activity detection (VAD)” functionality, as it is called. A data signal or voice-data signal received at the input I2 is transmitted to the VAD unit 7 and an absence of voice data to be transmitted in the data signal or the sole presence of background noise detected there. If no voice data is present, then a “silence insertion descriptor” (SID) transmission frame, as it is called, is generated by the VAD unit 7, which SID transmission frame is further processed in the transmitter unit 5 and then transmitted to the receiver unit 6 of the second communications device 3. This procedure is continued until such time as voice data is available again in the transmitter unit 5.

Furthermore, a “discontinuous transmission” (DTX) unit 8 is provided in the transmitter unit 5, which DTX unit is likewise connected via connection lines to the input I2 of the first communications device 2 and of the VAD unit 7. With the aid of the DTX unit 8, the SID transmission frames SID generated are counted during a coherent voice pause and the frequency of generation or transmission of the SID transmission frames SID during the voice pauses determined in this way.

In addition, the VAD unit 7 is connected via a connection line to a first “comfort noise generation” (CNG) unit 9 which is likewise connected via a further connection line to the input I2. The SID transmission frame SID generated in VAD unit 7 is transferred to the first CNG unit 9 before transmission to the second communications terminal 3 for further processing. In the first CNG unit 9, the background noise present in the voice pause is recorded by means of “comfort noise generation”-parameters CNP which reproduce in particular the loudness of the background noise by means of a “quantized energy level” parameter QEP and optionally the spectral properties of the background noise by means of multiple “quantized reflection coefficients” coefficients QRC. The comfort noise generation parameters CNP or the “quantized energy level” parameter QEP and the “quantized reflection coefficients” coefficients QRC are inserted in the SID transmission frame SID.

Furthermore, in the transmitter unit 5 transmitted voice data, for example, is packed in a payload-data transmission frame VP—frequently referred to in the literature as “voice frames”—, which, inserted in data packets not shown, is in turn transmitted via the IP-oriented telecommunications network 4. For this purpose, there is provided in the transmitter unit 5 of the first communications device 2 a first voice-signal unit 10 which is connected to the input 12 of the first telecommunications device 2. Via the first voice-signal unit 10, a voice-data signal received via the input I2 is encoded and inserted into a payload-data transmission frame VP. As indicated in FIG. 1, the generated payload-data transmission frames VP and the generated SID transmission frames SID are then inserted in data packets—not shown—and transmitted via the IP-oriented telecommunications network 4.

A multiplexing unit 11 is connected to the first voice-signal unit 10 and the first CNG unit 9 via connection lines, which multiplexer unit packs the payload-data transmission frame VP or the SID transmission frame SID for this purpose in at least one data packet and guides it to the output E2 of the first communications device 2 for transmission via the IP-oriented telecommunications network 4.

A demultiplexer unit 12 is connected to an I3 of the second communications device 3, which demultiplexer unit reads out the transmission frames VP and/or SID contained in the data packets received and forwards them either to a connected second voice-signal unit 13 or to a second “comfort noise generation” (CNG) unit 14.

By means of the second CNG unit 14, the information contained in the SID transmission frame SID is read out and analyzed in order to generate a background noise. There are also provided in the receiver unit 6, for example, a control unit 15 and a memory unit 16 which are provided for controlling the CNG unit 14 and the second voice-signal unit 13 and for storing data, in particular the “comfort noise generation” parameters CNP last received.

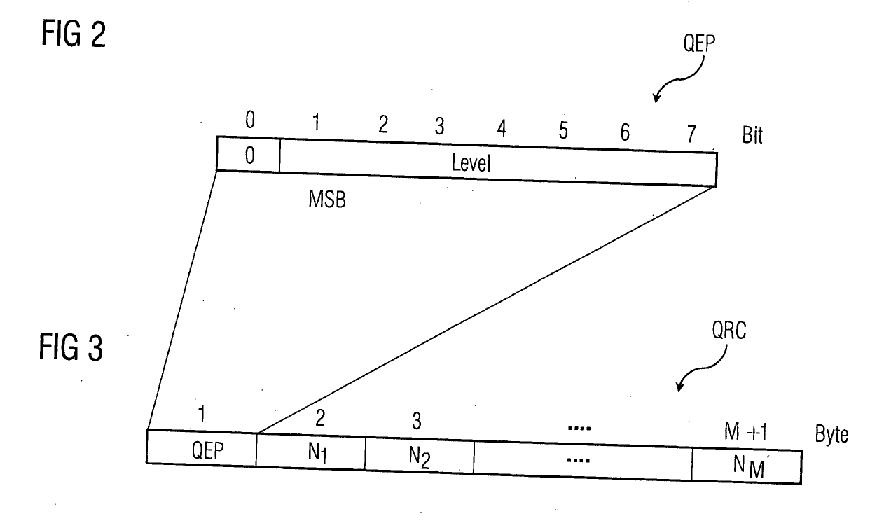

FIG. 2 shows by way of example the first byte within the SID transmission frame SID specifying the “quantized energy level” parameters QEP. The noise-signal level is given here in −dBov, whereby values from 0 to 127 and from 0 to −127 dBov can be mapped. 8 bits are provided for showing the aforementioned range of values of the “quantized energy level” parameter QEP, said bits corresponding to the first byte of the SID transmission frame SID. Here, the bit comprising the zeroized bit position is indiscriminately allocated the value 0 and the remaining first to seventh bits reproduce the actual value of the noise-signal level, the “Most Significant Bit” (MSB) being provided in the first bit position.

The “quantized reflection coefficients” QRC are transmitted by means of the second to M+1th bytes within the SID transmission frame SID, the first QRC coefficient N₁ , being transmitted using the first byte, the second QRC coefficient N₂ using the second byte, etc. The Mth QRC coefficient N_{M} is finally transmitted last, the order of the digital filter, via which the background noise is formed from a Gaussian random signal or stochastic random noise signal, being determined here by the number M of QRC coefficients QRC. Normally, digital filters, in particular, synthesizing filters of the order M =10 to 15 are used.

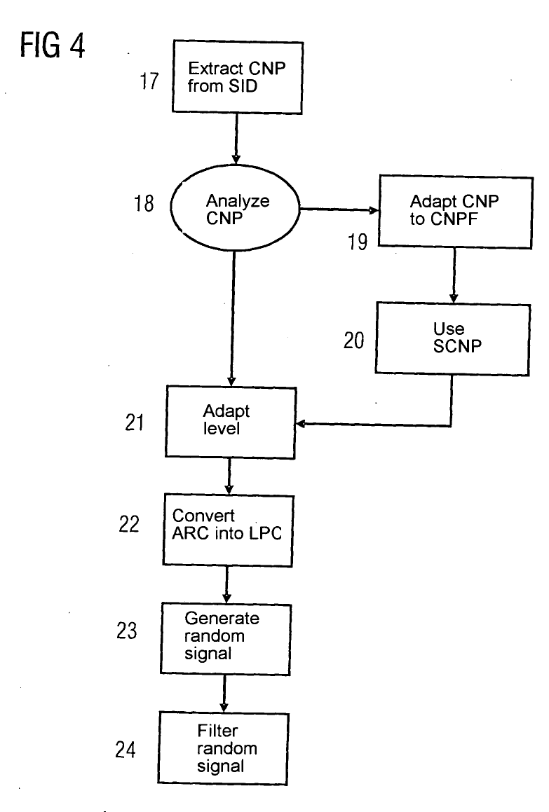

The method for adapting “comfort noise generation” parameters CNP for generating an improved background noise, transmitted in at least one SID transmission frame SID, is explained in detail below with reference to the flow diagram shown in FIG. 4.

If an SID transmission frame SID with “comfort noise generation” parameters CNP contained therein is received by the second CNG unit 14, then, in a first step 17, these are removed from the SID transmission frame SID. If no new “comfort noise generation” parameters CNP are contained in the SID transmission frame SID, then the “comfort noise generation” parameters CNP last filed in the memory unit 16 are used for generating the background noise.

In a second step 18, the CNG parameters CNP removed are subjected to an analysis, such that these are first split into the “quantized energy level” parameter QEP and the “quantized reflection coefficients” QRC and the number M of transmitted QRC coefficients N₁-N_{M} determined in this process. In addition, the parameter values are checked byte-by-byte to ascertain whether these lie within a predetermined range, that is [lacuna] by a predetermined CNG parameter format CNPF, or exceed a predetermined number of bytes. By this means, a predetermined number of filter coefficients, in the present exemplary embodiment M=10 QRC coefficients N₁- N₁₀ , is stipulated by the predetermined CNG parameter format CNPF . Studies have shown that where M=10 filter coefficients are used the best results are achieved in terms of transmission rate and quality of the background noise generated. Consequently, only those CNG parameters CNP read out from the SID transmission frame, that meet these requirements, are used directly without adaptation for filtering.

All the remaining CNG parameters CNP, i.e. those which do not conform to the stipulations, are adapted in a third step 19 firstly to the predetermined CNG parameter format CNPF . To do this, superfluous filter coefficients, i.e. those which exceed the number of 11 bytes (QEL parameter QEP=first byte; QRC coefficients N₁-N₁₀=second to eleventh byte) 12 to Nth bytes of the SID transmission frame SID are first cut off and thus removed. Advantageously, standard filters can as a result be used for generating the background noise signal, as a result of which [lacuna] the adaptation of the filter arrangement of the filters provided in the different transmitter and receiver units can be waived.

In a fourth step 20, the content of the CNG parameters CNP now consisting of a maximum of eleven bytes is checked, i.e. the QEL parameters QEP and the remaining QRC coefficients QRC are more precisely analyzed and, for example, missing or incomplete or errored or incompatible parameters replaced by set CNG parameters SCNP. The set CNG parameters SCNP are taken from a “set of golden parameters” SGP which is stored in the memory unit 16.

The “set of golden parameters” SGP comprises in a preferred embodiment a golden QEL parameter GQEP and ten golden QRC coefficients GQRC which have been determined by extensive analyses of numerous test files with standardized voice samples or voice samples obtained in the experimental station. To this end, a spectral analysis of the voice samples was produced after these were subjected to high-pass filtering, window-filtering and the application of an autocorrelation function and the Levison-Durbin algorithm, the “set of golden parameters” SGP being chosen such that the background noise generated comes to lie in a uniform frequency range between 900 and 3400 Hz. Here, the signal energy received is distributed over the stated frequency range almost evenly between 900 and 3400. Care was taken to ensure, in particular, that only few frequency proportions fall within the frequency range of 300- 900 Hz that produces a louder impression to the human ear.

The CNG parameters CNP* adapted in this way are then equalized in a fifth step 21 with regard to the signal level of the background noise that can be generated by these. This is carried out, for example, analogously to the method defmed in ITU standard G.711 appendix II.

In a further sixth step 22, the adapted QRC coefficients QRC* are converted using the Levison Durbin algorithm into “linear prediction coefficient (LPC)” coefficients LPC. To do this, golden LPC coefficients LPC, which have already been computed for the golden QRC coefficients GQRC and which are likewise stored in the memory unit 16, can be used directly, saving resources, i.e. a computationally intensive determination of the relevant LPC coefficients LPC for the QRC coefficients QRC* taken from the “set of golden parameters” SGP can be waived.

In a seventh step 23, a Gaussian random signal is generated which is subjected to calibration.

Finally, in an eighth step 24, the Gaussian random signal generated is fed through a filtering or a synthesizing filtering via a filter unit to which the LPC coefficients LPC have been applied and by this means the background noise signal generated which is superimposed on the voice-data signal.

The invention was described hereinabove with reference to multiple exemplary embodiments. It will be understood that numerous modifications and variations are possible without thereby departing from the inventive idea underlying the invention.

1.-10. (canceled)

11. A method for the adaptation of comfort noise generation parameters which are provided for generating a background noise signal in a telecommunications system including a packet-oriented telecommunications network and first and second communications devices operatively connected to the packet-oriented telecommunications network, the method comprising:
generating the comfort noise generation parameters by the first communications device;
inserting the comfort noise generation parameters in at least one silence insertion descriptor transmission frame;
transmitting the silence insertion descriptor transmission frame toward the second communications device via the packet-oriented telecommunications network by the first communications device;
receiving the silence insertion descriptor transmission frame having the comfort noise generation parameters by the second communications device; and
comparing the transmitted comfort noise generation parameters with a comfort noise generation parameter format,
wherein if the comparison shows a deviation the transmitted comfort noise generation parameters are adapted to the comfort noise generation parameter format by removing an individual comfort noise generation parameter and/or,
wherein if the comparison shows missing, errored, or incompatible transmitted comfort noise generation parameters, the transmitted comfort noise generation parameters are adapted to the comfort noise generation parameter format by replacing individual comfort noise generation parameters with a comfort noise generation parameter set.

12. The method according to claim 11, wherein the transmitted comfort noise generation parameters include a quantized energy level parameter and a plurality of quantized reflection coefficients.

13. The method according to claim 11, wherein the comfort noise generation parameter set is selected from a golden parameter set corresponding to a comfort noise generation parameter format.

14. The method according to claim 13, wherein the comfort noise generation parameter set is selected such that a signal energy of a background noise signal generated via the comfort noise generation parameter set is distributed essentially evenly over the frequency range from 900 to 3400 Hz.

15. The method according to claim 12, wherein a quantized reflection coefficient is removed from the transmitted comfort noise generation parameters in order to adapt to the comfort noise generation parameter format.

16. The method according to claim 14, wherein a quantized reflection coefficient is removed from the transmitted comfort noise generation parameters in order to adapt to the comfort noise generation parameter format.

17. The method according to claim 16, wherein the transmitted comfort noise generation parameters are limited to a maximum of 11 parameters comprising one quantized energy level parameter and ten quantized reflection coefficient parameters.

18. The method according to claim 12, wherein the transmitted comfort noise generation parameters are limited to a maximum of 11 parameters comprising one quantized energy level parameter and ten quantized reflection coefficient parameters.

19. The method according to claim 17, wherein a level of the background noise signal is communicated via the quantized energy level parameter and the background noise signal is communicated via the quantized reflection coefficient parameters.

20. The method according to claim 12, wherein a level of a background noise signal to be generated by the comfort noise generation parameter set is communicated via the quantized energy level parameter and the background noise signal to be generated is communicated via the quantized reflection coefficient parameters.

21. The method according to claim 13, wherein the golden parameter set is determined via a spectral analyses of test data signals having frequencies in the range from 300 to 3400 Hz.

22. The method according to claim 21, wherein the range is from 900 to 3400 Hz.

23. The method according to claim 12, further comprising:
generating a Gaussian random signal at a receiver end; and
filtering the Gaussian random signal via a synthesizing filter unit, for generating a background noise signal related to the comfort noise generation parameter set.

24. The method according to claim 19, further comprising:
generating a Gaussian random signal at a receiver end; and
filtering the Gaussian random signal via a synthesizing filter unit, for generating a background noise signal related to the comfort noise generation parameter set.

25. The method according to claim 23, wherein at least some of the quantized reflection coefficients are adapted using the Gaussian random signal, the method further comprising:
converting the adapted quantized reflection coefficients into Linear Prediction Coefficients using a Levison Durbin Algorithm; and
feeding the converted quantized reflection coefficients to the synthesizing filter unit.
